(19) United States
(12) Patent Application Publication
(10) Pub. No.: US 2026/0340553 A1
(43) Pub. Date: Oct. 29, 2026

(54) SYSTEMS AND METHODS FOR PRODUCTION OPTIMIZATION FOR DRAWDOWN MANAGEMENT USING HIGH FREQUENCY DYNAMIC DATA

(71) Applicant: ConocoPhillips Company, Houston, TX (US)

(72) Inventor: Izuchukwu Samuel ILONZE, Houston, TX (US)

(21) Appl. No.: 19/576,283

(22) Filed: Mar. 24, 2026

Related U.S. Application Data
(60) Provisional application No. 63/776,603, filed on Mar. 24, 2025.

(51) Int. Cl. G06Q 10/0637; G06Q 10/04; G06Q 50/02

(52) U.S. Cl. CPC G06Q 10/0637; G06Q 10/04; G06Q 50/02

(57) ABSTRACT

Implementations described herein provide systems and methods for production optimization. In one implementation, well data is received and at least one rate and time dependent property is determined using the well data. A plot is generated of the at least one rate and time dependent property relative to a pressure of the well. The plot is analyzed to determine a trend and a well drawdown strategy is generated based on the trend.

### CROSS-REFERENCE TO RELATED APPLICATIONS

The present application claims priority to U.S. Provisional Patent Application No. 63/776,603 filed on Mar. 24, 2025, which is incorporated by reference in its entirety herein.

### FIELD

Aspects of the present disclosure generally relate to production optimization of reservoirs, and more particularly to using high frequency dynamic data to develop drawdown management strategies.

### BACKGROUND

Drawdown strategies of reservoirs are typically driven by production demands. In some instances, the drawdown strategy is developed without consideration of potential adverse effects. For example, if the wells of the reservoir are being pulled too hard, the production may be impaired and/or damage may occur to the wells, which in some cases, may be irreversible. If the wells are pulled on too hard, damage may occur within the wells. In some instances, the wells may not recover from the damage. It is with these observations in mind, among others, that various aspects of the present disclosure were conceived and developed.

### SUMMARY

In some aspects, the techniques described herein relate to a method for optimizing production of a reservoir, the method including: receiving well data corresponding to a well; determining at least one rate and time dependent property using the well data; generating a plot of the at least one rate and time dependent property relative to a pressure of the well; analyzing the plot to determine a trend; and generating a well drawdown strategy based on the trend.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example production optimization platform.

FIG. 2 shows an example computing system that may implement various systems and methods discussed herein.

FIG. 3 depicts an example method for single well production optimization.

FIG. 4 depicts an example method for multi-well production optimization.

FIG. 5 depicts an example pressure transient analysis.

FIG. 6 depicts an example pressure transient analysis.

FIG. 7 depicts an example rate transient analysis.

FIG. 8 depicts an example rate transient analysis.

FIG. 9 depicts an example pressure transient analysis.

FIG. 10 depicts an example plot of a plurality of build-ups.

FIG. 11 depicts an example comparison of two build-ups.

FIG. 12 depicts an example of a comparison of a plurality of build-ups.

FIG. 13 depicts an example of a comparison of a plurality of build-ups.

FIG. 14 depicts an example of a comparison of a plurality of build-ups.

### DETAILED DESCRIPTION

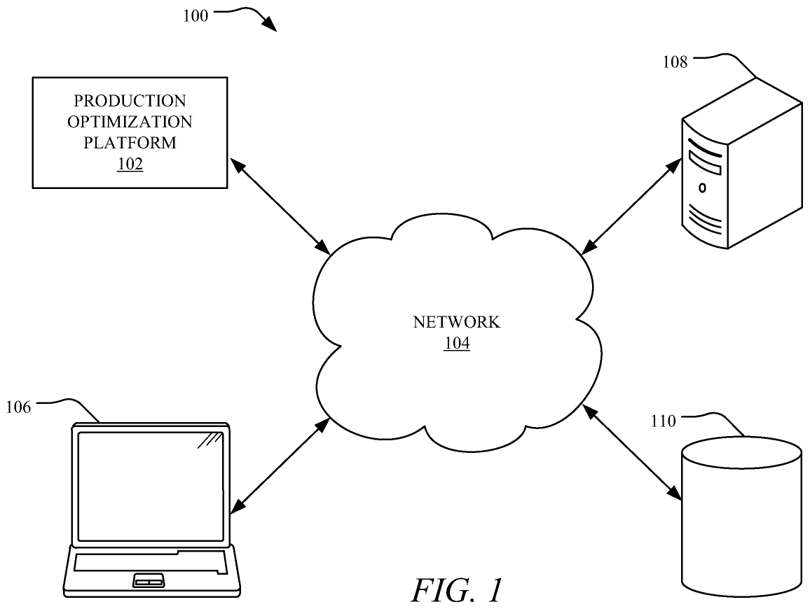

FIG. 1 illustrates an example network environment 100 for implementing the various systems and methods, as described herein including a production optimization platform 102. A network 104 can be used by one or more computing or data storage devices for implementing the production optimization platform 102. The production optimization platform 102 may be a remote service, software as a service (SaaS) and/or cloud service for collecting and aggregating data from multiple sources. The production optimization platform 102 can include software modules for processing high frequency dynamic data to generate optimized drawdown strategies. In some examples, drawdown may correspond to a relationship between a reservoir pressure and a flowing bottomhole pressure, with the drawdown strategy including an approach of controlling a reservoir pressure to elicit a desired response in production rate. For instance, any of the software operations (e.g., the computing system 200, etc.) discussed herein can be incorporated into the production optimization platform 102 (e.g., as executable python script) to scale-up the software components and make them accessible to a variety of users in multiple locations using many different types of computing devices.

As used herein, high frequency dynamic data refers to production data or well monitoring data collected at relatively short sampling intervals, such as seconds, minutes, or hours, including pressure measurements, production rate measurements, flowback data, or combinations thereof. Such data may be collected using downhole gauges, surface sensors, or other monitoring devices. As used herein, a well drawdown strategy may include a plan for controlling one or more production parameters of a well, including pressure, flowback rate, production rate, choke setting, or timing of production operations.

In some implementations, various components of the production optimization platform 102, one or more user devices 106, one or more databases 110, and/or other network components or computing devices described herein are communicatively connected to the network 104. Examples of the user devices 106 include a terminal, personal computer, a smartphone, a tablet, a mobile computer, a workstation, and/or the like.

A server 108 may, in some instances, host the system including the production optimization platform 102. In one implementation, the server 108 also hosts a website or an application that users may visit to access the network environment 100, including the production optimization platform 102. The server 108 may be one single server, a plurality of servers with each such server being a physical server or a virtual machine, or a collection of both physical servers and virtual machines. In another implementation, a cloud hosts one or more components of the system. The production optimization platform 102, the user devices 106, the server 108, and other resources connected to the network 104 may access one or more additional servers for access to one or more websites, applications, web services interfaces, etc. that are used for generating the drawdown strategy.

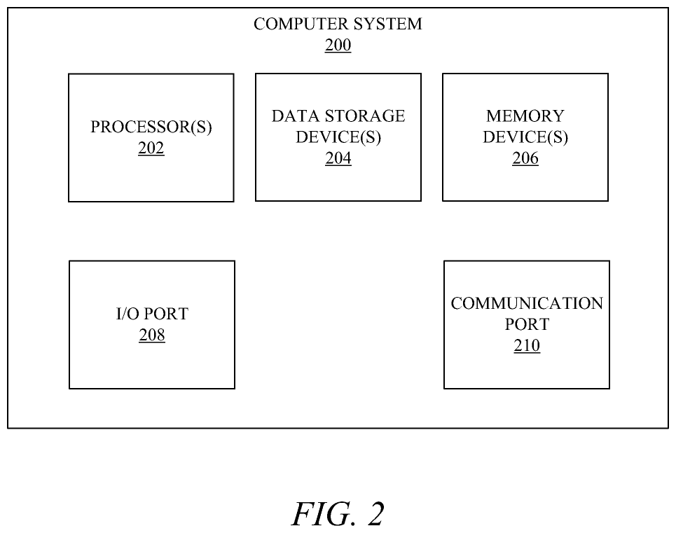

FIG. 2 shows an example of a computing system 200 having one or more computing units that may implement various systems and methods discussed herein is provided. The computing system 200 may be used to implement the production optimization platform 102 as one or more software components and can form a part of the network environment 100, and other computing or network devices. In some instances, the computing system 200 may be similar or identical to the user device 106, the server 108, the one or more databases 110, combinations thereof and the like. It will be appreciated that specific implementations of these devices may be of differing possible specific computing architectures not all of which are specifically discussed herein but will be understood by those of ordinary skill in the art.

The computing system 200 may be capable of executing a computer program product and/or a computer process, described above. Data and program files may be input to the computing system 200, which reads the files and executes the programs therein. For instance, the computing system 200 can store the production optimization platform 102 as one or more applications that receive various inputs (e.g., the well build-up data) and execute multiple algorithmic steps (as discussed herein, for example in the methods 300, 400 described above), to generate the well drawdown strategy.

Some of the elements of the computing system 200 are shown in FIG. 2, including one or more hardware processors 202, one or more data storage devices 204, such as memory devices, and/or one or more ports 208 or 210. Additionally, other elements that will be recognized by those skilled in the art may be included in the computing system 200 but are not explicitly depicted in FIG. 2 or discussed further herein. Various elements of the computing system 200 may communicate with one another by way of one or more communication buses, point-to-point communication paths, or other communication means not explicitly depicted in FIG. 2.

The processor 202 may include, for example, a central processing unit (CPU), a microprocessor, a microcontroller, a digital signal processor (DSP), and/or one or more internal levels of cache. There may be one or more processors 202, such that the processor 202 comprises a single central-processing unit, or a plurality of processing units capable of executing instructions and performing operations in parallel with each other, commonly referred to as a parallel processing environment.

The computing system 200 may be standalone computer, a distributed computer, or any other type of computer, such as one or more external computers made available via a cloud computing architecture. The presently described technology is optionally implemented in software stored on the data storage device(s) 204, (e.g., memory device(s)), and/or communicated via one or more of the ports 208 or 210, thereby transforming the computing system 200 in FIG. 2 to a special purpose machine for implementing the operations described herein. Examples of the computing system 200 include personal computers, terminals, workstations, mobile phones, tablets, laptops, personal computers, multimedia consoles, gaming consoles, set top boxes, and the like.

The one or more data storage devices 204 may include any non-volatile data storage device capable of storing data generated or employed within the computing system 200, such as computer executable instructions for performing a computer process, which may include instructions of both application programs and an operating system (OS) that manages the various components of the computing system 200. The data storage devices 204 may include, without limitation, magnetic disk drives, optical disk drives, solid state drives (SSDs), flash drives, and the like. The data storage devices 204 may include one or more memory devices such as removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices can include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 204, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures. The machine-readable media may store instructions that, when executed by the processor, cause the systems to perform the operations disclosed herein.

In some implementations, the computing system 200 includes one or more ports, such as an input/output (I/O) port 208 and a communication port 210, for communicating with other computing, network, or reservoir development devices. It will be appreciated that the ports 208 and 210 may be combined or separate and that more or fewer ports may be included in the computing system 200.

The I/O port 208 may be connected to an I/O device, or other device, by which information is input to or output from the computing system 200. Such I/O devices may include, without limitation, one or more input devices, output devices, and/or environment transducer devices.

In some implementations, the input devices convert a human-generated signal, such as, human voice, physical movement, physical touch or pressure, and/or the like, into electrical signals as input data into the computing system 200 via the I/O port 208. Similarly, the output devices may convert electrical signals received from computing system 200 via the I/O port 208 into signals that may be sensed as output by a human, such as sound, light, and/or touch. The input device may be an alphanumeric input device, including alphanumeric and other keys for communicating information and/or command selections to the processor 202 via the I/O port 208. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen. Furthermore, the input devices and/or output devices can include a user interface (UI), for instance, to present the drawdown strategy.

In some implementations, a communication port 210 is connected to a network (e.g., the network 104) by way of which the computing system 200 may receive network data useful in executing the methods and systems set out herein as well as transmitting information and network configuration changes determined thereby. Stated differently, the communication port 210 connects the computing system 200 to one or more communication interface devices configured to transmit and/or receive information between the computing system 200 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 210 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 210 may communicate with an antenna or other link for electromagnetic signal transmission and/or reception.

The computing system 200 set forth in FIG. 2 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be used. In the present disclosure, the methods and operations disclosed herein may be implemented as sets of instructions or software readable by a device. These sets of instructions can convert the computing system 200 into a special purpose device for generating the drawdown strategy (e.g., a new type of file). As such, the computing system 200 can integrate the production optimization platform 102 into a practical application by providing improved visualization the subterranean feature, thus improving the technological field of reservoir modeling for the oil/gas industry. For instance, the implementation of the production optimization platform 102 on the computing system 200 can improve the identification of locally homogenous features and locations of such features, such that well construction placement is improved.

In some instances, the production optimization platform 102 may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

The instructions, media for conveying such instructions, computing resources for executing them, and other structures for supporting such computing resources can be means for providing the functions described in these disclosures.

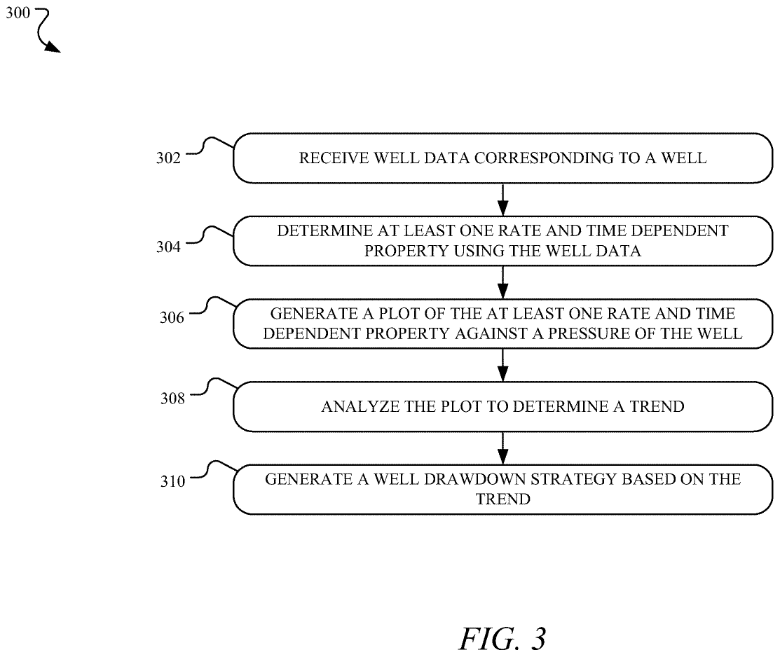

FIG. 3 depicts an example method 300 for single well production optimization. The method 300 can be performed at least by the systems depicted in FIGS. 1 and 2. In some examples, at operation 302, the method 300 includes receiving well data corresponding to a well.

The well data may include build-up data, production rate data, pressure data, flowback data, or other well testing data corresponding to the well. In some examples, the build-up data may include the results of a pressure build-up test performed after a well is shut in. The build-up data may contain data related to the well flow capacity, skin effect, permeability thickness, and other data. At operation 304, the method 300 includes determining at least one rate and time dependent property using the well data. The at least one rate and time dependent property may include a flow capacity or a skin effect of the well data. At operation 306, the method includes generating a plot of the at least one rate and time dependent property relative to a pressure of the well. At operation 308, the method 300 includes analyzing the plot to determine a trend. At operation 310, the method includes generating a well drawdown strategy based on the trend. The well drawdown strategy may be applied to the well in a future time or to future wells.

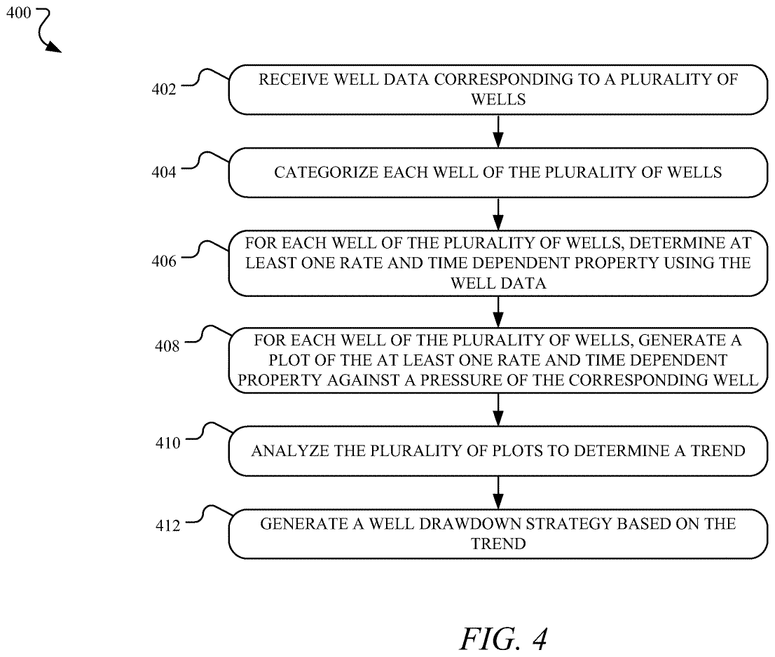

FIG. 4 depicts an example method 400 for multi-well production optimization. The method 400 can be performed at least by the systems depicted in FIGS. 1 and 2. In some examples, at operation 402, the method 400 includes receiving well data corresponding to a plurality of wells. The well data may include build-up data, including flow and pressure data, corresponding to each of the plurality of wells. At operation 404, the method 400 includes categorizing each well of the plurality of wells. The categories may include low drawdown, medium drawdown, and high drawdown. At operation 406, the method 400 includes determining, for each well of the plurality of wells, at least one rate and time dependent property using the well data. The at least one rate and time dependent property may include a flow capacity or a skin effect of the well data. At operation 408, the method 400 includes generating, for each well of the plurality of wells, a plot of the at least one rate and time dependent property relative to a pressure of the well. In some instances, the plots corresponding to each well of the plurality of wells are overlaid onto a composite plot. At operation 410, the method 400 includes analyzing the plurality of plots to determine a trend. At operation 412, the method 400 includes generating a well drawdown strategy based on the trend. The well drawdown strategy may be applied to the well in a future time or to future wells.

In some instances, the identified trend may be used to determine whether a well should be produced under a lower drawdown condition, a higher drawdown condition, or a modified flowback strategy. In some instances, the trends identified from the plots may include flow regimes such as linear flow, bilinear flow, unstable flow behavior, interference responses, high-rate flow back (HRFB) conditions, low-rate flow back (LRFB) conditions, or other reservoir flow behaviors.

It is to be understood that the specific arrangement, order, or hierarchy of steps or operations in the systems and methods depicted in FIGS. 3 and 4 and throughout this disclosure are instances of example approaches and can be rearranged while remaining within the disclosed subject matter. For instance, any of the steps depicted in FIGS. 3 and 4 and throughout this disclosure may be omitted, repeated, performed in parallel, performed in a different order, and/or combined with any other of the steps depicted in FIGS. 3 and 4 and throughout this disclosure.

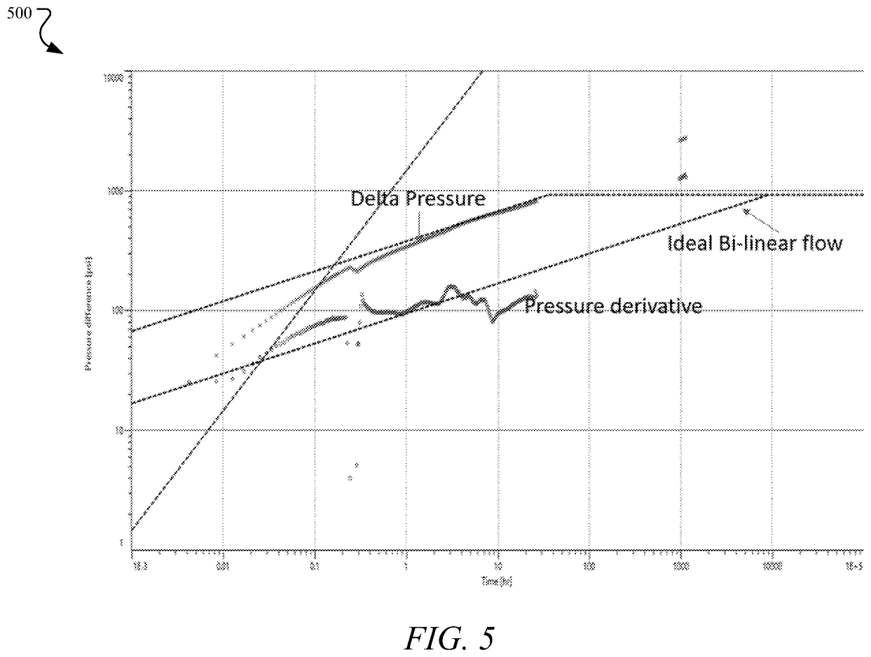

FIGS. 5-14 depict examples of plots which are generated by the methods 300, 400 described above and examples of trends which are identified based on the plots. The example plots may be generated using well data and analyzed by the production optimization platform to determine flow regimes, skin effects, and interference behavior.

FIG. 5 depicts an example pressure transient analysis. In particular, plot 500 illustrates a pressure transient plot generated by the production optimization platform 102 using well data received from a build-up test or other well testing operation. The plot 500 may represent pressure and derivative responses as a function of time. As illustrated in plot 500, an early-time region exhibits a linear flow regime, which may correspond to fracture-dominated flow near the wellbore. During a middle-time period, the response transitions to a bilinear flow regime indicative of interaction between fracture flow and formation flow. The response further transitions to a higher skin condition. The elevated skin value may correspond to a rate and time dependent property determined from the well data and may indicate potential formation damage associated with high-rate flow back (HRFB). The identification of such a trend may be used by the production optimization platform 102 to generate or modify a well drawdown strategy.

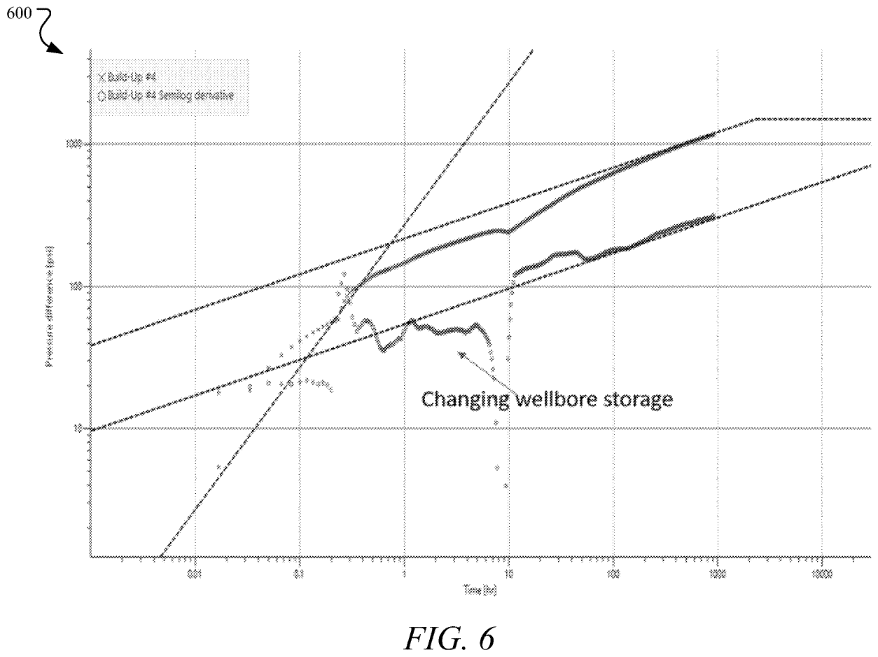

FIG. 6 depicts another example pressure transient analysis. In particular, plot 600 illustrates a pressure transient plot generated from well data analyzed by the production optimization platform 102. As shown in plot 600, the early-time portion of the plot indicates changing wellbore storage effects. The middle-time region exhibits bilinear flow behavior. Analysis of the rate and time dependent properties derived from the well data indicates that little or no skin damage is present. The observed trend may correspond to a low-rate flow back (LRFB) condition. Identification of LRFB behavior may be incorporated into a drawdown strategy to maintain fracture conductivity and reduce potential well damage.

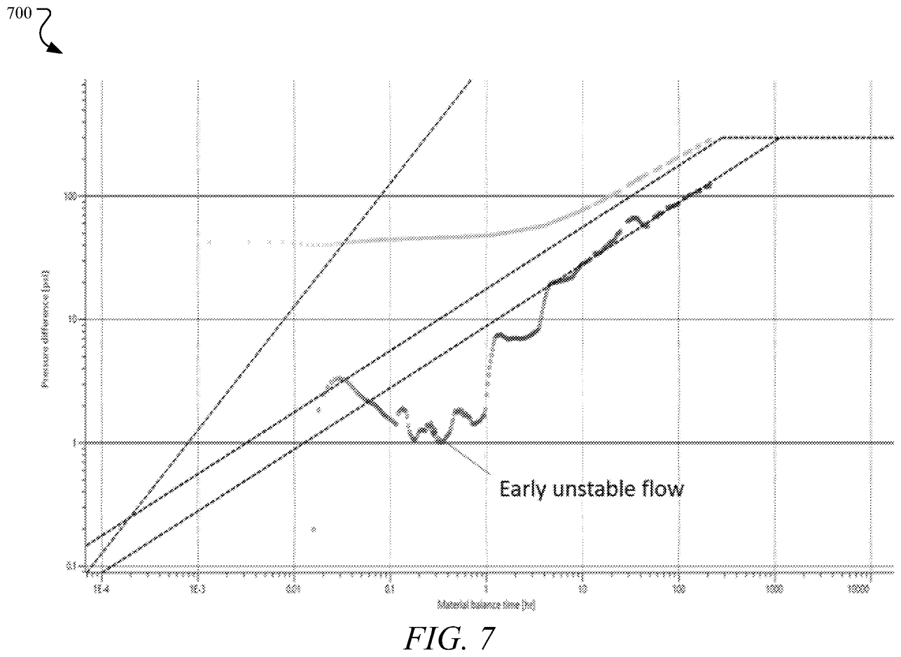

FIG. 7 depicts an example rate transient analysis. In particular, plot 700 illustrates production rate and derivative data generated from high frequency dynamic well data received by the production optimization platform 102. As illustrated in plot 700, early-time data exhibit unstable flow behavior associated with elevated skin effects, which may correspond to near-wellbore restrictions. During a middle-time period, the response transitions to a linear flow regime indicative of fracture-dominated reservoir flow. The analysis of the plot 700 indicates a positive total skin value corresponding to a rate and time dependent property determined from the well data. Additionally, the absence of interference signals in the late-time response indicates that the well may be producing without significant communication with adjacent wells or fractures.

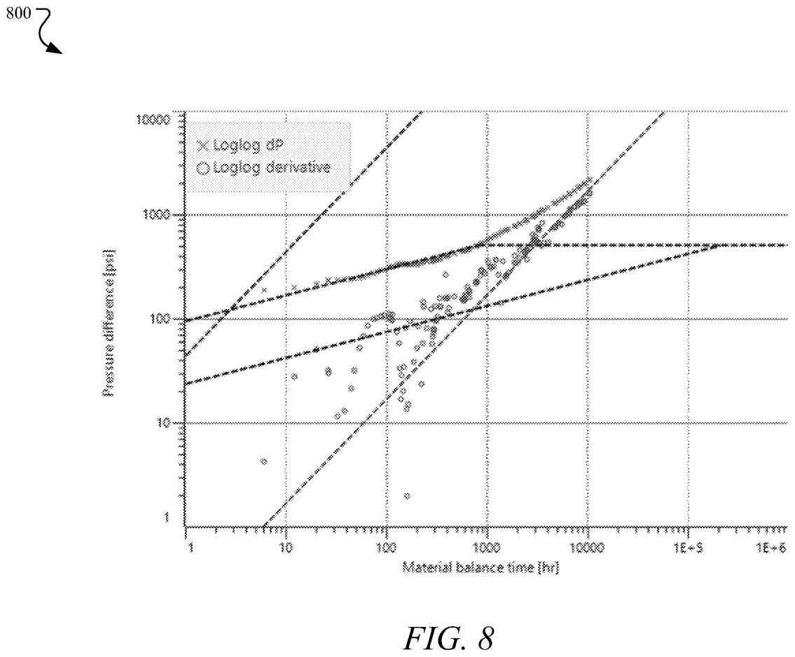

FIG. 8 depicts another example rate transient analysis. In particular, plot 800 illustrates rate transient behavior evaluated by the production optimization platform 102 to identify flow regimes and potential interference effects. As illustrated in plot 800, bilinear flow behavior is observed during early-time and middle-time regions of the plot. At later times, the response exhibits interference behavior that may correspond to fracture-to-fracture interaction or communication between neighboring wells. The analysis of plot 800 indicates that the well exhibits little or no skin damage. The identification of late-time interference trends may be incorporated into a multi-well drawdown strategy generated according to the method 400.

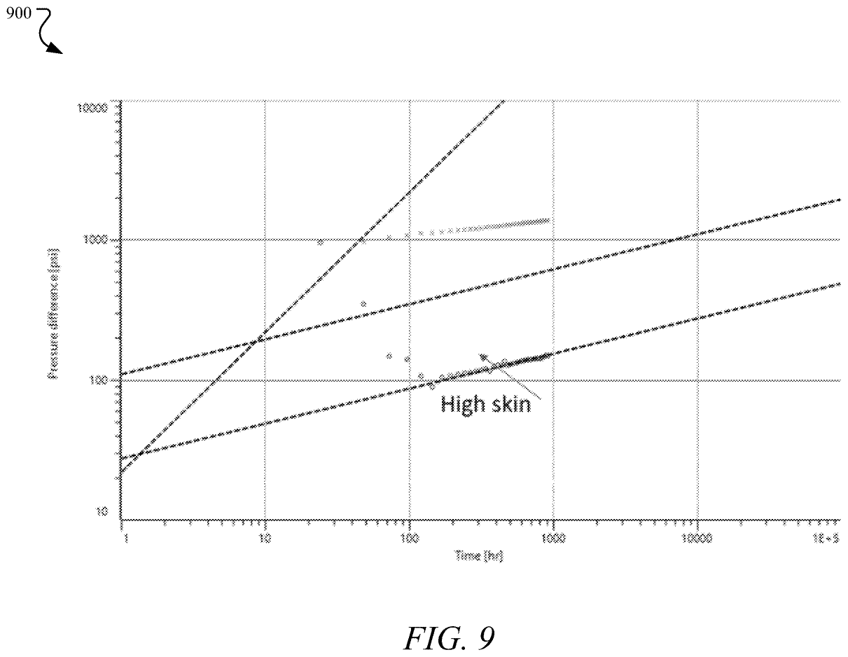

FIG. 9 depicts another example pressure transient analysis. In particular, plot 900 illustrates pressure transient behavior derived from well data obtained during a pressure build-up test. The early-time portion of plot 900 provides limited resolution due to gauge constraints, which may limit interpretation of wellbore storage effects. During the middle-time region, the plot exhibits bilinear flow behavior. The analysis of the plot 900 indicates relatively high skin damage associated with the well. In some implementations, a portion of the observed skin value may be attributable to frictional losses within the wellbore or fracture network rather than formation damage alone.

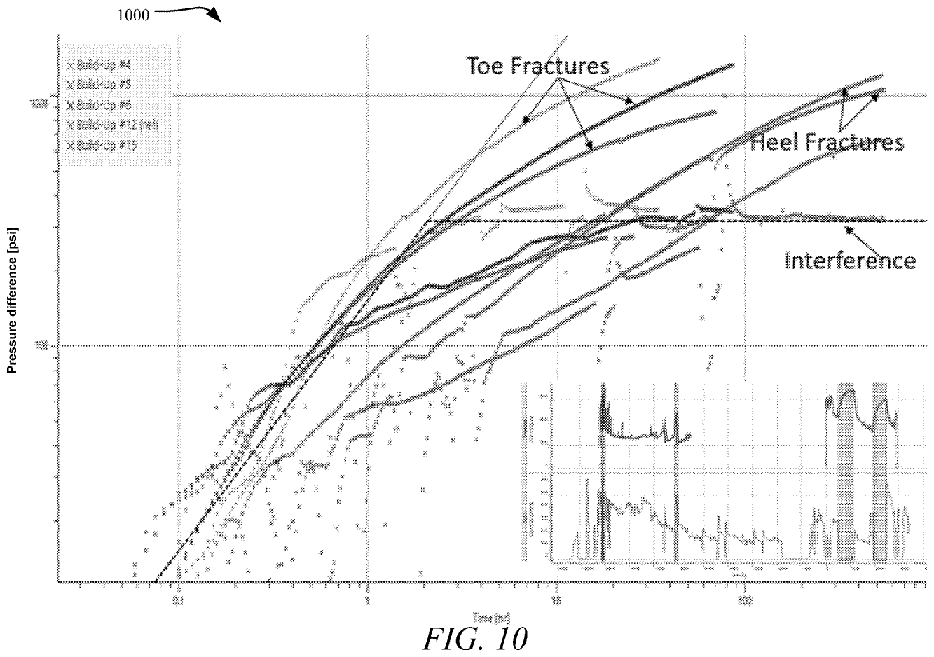

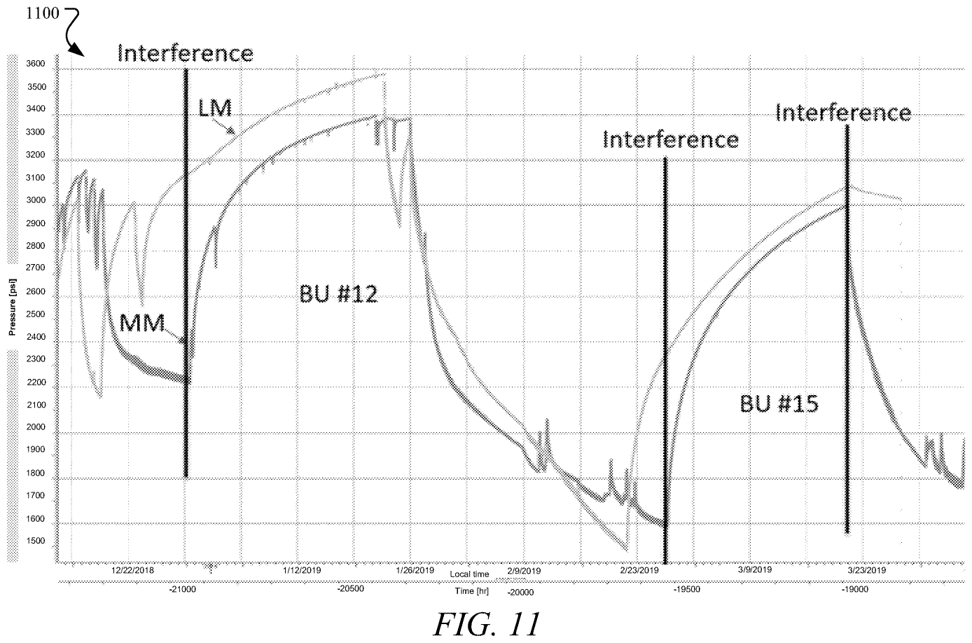

FIG. 10 depicts an example plot of a plurality of build-ups. Each build-up may correspond to a respective pressure build-up test performed during a sequence of well testing events. In particular, plot 1000 illustrates pressure responses from multiple pressure build-up tests performed on a well after shut-in events. Each build-up corresponds to well data collected following a respective shut-in event. As illustrated in plot 1000, build-ups measured near the toe region of the well exhibit approximately a one-quarter slope response, which may correspond to relatively low-conductivity fracture flow and potential fracture damage. These toe responses also exhibit late-time interference behavior. In contrast, build-ups measured near the heel region exhibit approximately a one-half slope response characteristic of higher-conductivity fracture flow. The analysis of these build-ups indicates varying skin values and differences in flow capacity along the wellbore. The comparison suggests that heel fractures may exhibit greater flow efficiency than toe fractures. Additionally, interference magnitude observed during build-up #12 is greater than interference observed during build-up #15. A reduction in total flow capacity between build-ups #12 and #15 may indicate pressure-dependent fracture conductivity.

FIG. 11 depicts an example comparison of two build-ups. In particular, plot 1100 illustrates pressure responses corresponding to two pressure build-up tests obtained from well data analyzed by the production optimization platform 102. As illustrated in plot 1100, an interference response is observed during build-up #12. Build-up #15 also exhibits an interference response. In some implementations, build-up #15 may be selected for further analysis by the production optimization platform 102 to quantify the interference trend and incorporate the results into a drawdown management strategy.

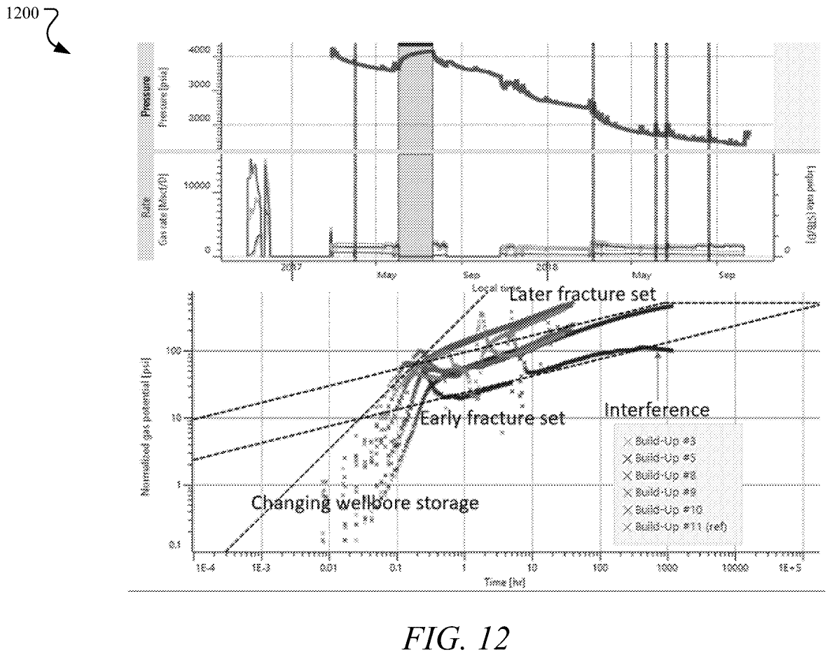

FIG. 12 depicts an example comparison of a plurality of build-ups. In particular, plot 1200 illustrates pressure responses obtained from multiple pressure build-up tests performed over time. Early-time portions of the plot exhibit changing wellbore storage effects. Six build-ups are identified as valid for analysis. The build-ups collectively exhibit complex infinite-conductivity fracture flow behavior. Two fracture sets are identified based on the analysis of the well data. Fractures associated with earlier operations (e.g., approximately 2017) exhibit higher flow capacity relative to fractures associated with later operations (e.g., approximately 2018). The analysis indicates that skin values remain generally consistent across the fracture sets. Late-time behavior associated with build-up #5 indicates potential interference.

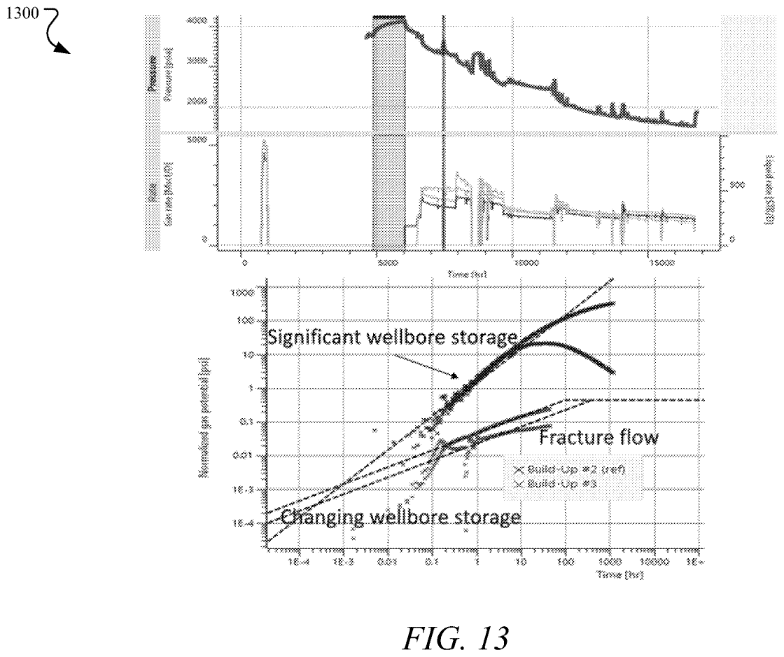

FIG. 13 depicts an example comparison of a plurality of build-ups. In particular, plot 1300 illustrates pressure responses corresponding to multiple build-up tests. Two build-ups are identified as valid for analysis. An initial build-up (BU #2) is influenced by a shut-in event, which produces an interference response in the measured data. Build-up #2 also exhibits significant wellbore storage effects. A subsequent build-up (build-up #3) exhibits changing wellbore storage during the early-time regime and transitions to fracture-dominated flow behavior during the middle-time regime.

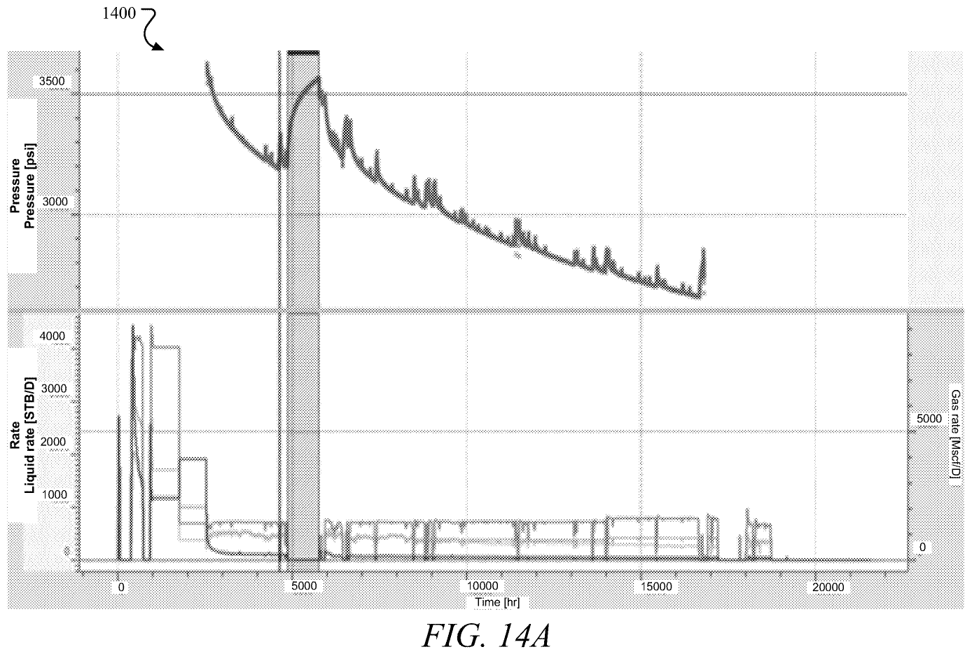

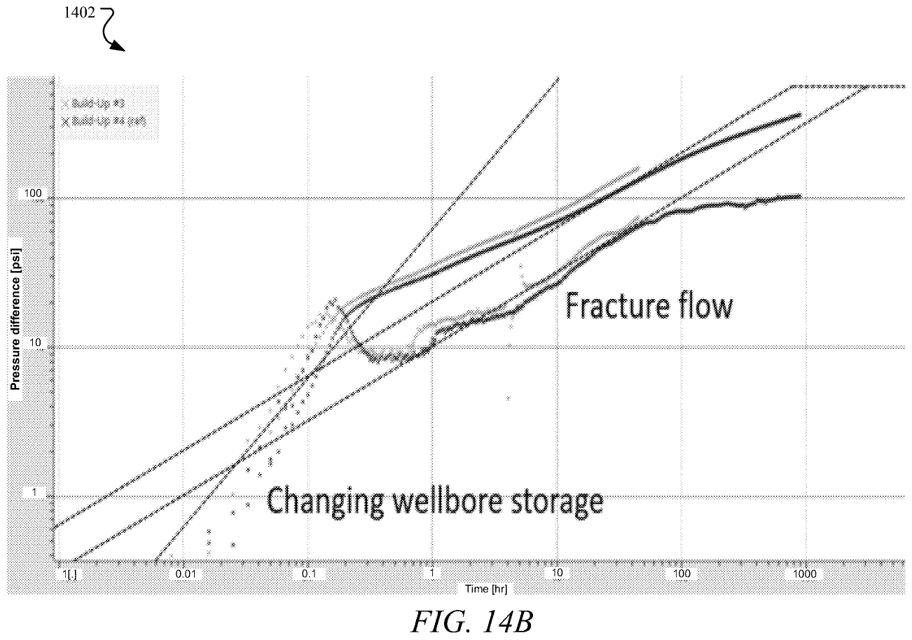

FIG. 14 depicts an example comparison of a plurality of build-ups. In particular, plot 1400 illustrates pressure responses obtained from multiple pressure build-up tests analyzed under comparable conditions. Two build-ups are identified as valid for analysis. Both build-ups exhibit changing wellbore storage effects during early time followed by fracture-dominated flow during middle time. The responses are generally consistent and exhibit similar total skin values. In some implementations, a total equivalent production rate is used to normalize the responses for comparison by the production optimization platform 102 during the generation of the drawdown strategy.

Each of the plots depicted in FIGS. 5-14 are examples of plots generated by the production optimization platform. The analysis of the plot is further incorporated into the well drawdown strategy, as described in the methods 300, 400 described above.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method for optimizing production of a reservoir, the method comprising:
receiving well data corresponding to a well;
determining at least one rate and time dependent property using the well data;
generating a plot of the at least one rate and time dependent property relative to a pressure of the well;
analyzing the plot to determine a trend; and
generating a well drawdown strategy based on the trend.

2. The method of claim 1, wherein the well data comprises build-up data.

3. The method of claim 2, wherein the build-up data comprises results of a pressure build-up test performed after the well is shut in.

4. The method of claim 1, wherein the well data comprises high frequency dynamic data including at least one of pressure measurements, production rate measurements, or flowback data.

5. The method of claim 1, wherein the at least one rate and time dependent property comprises a flow capacity or a skin effect of the well data.

6. The method of claim 1, wherein the trend comprises at least one of a linear flow, a bilinear flow, an unstable flow, a high-rate flow back (HRFB), or a low-rate flow back (LRFB).

7. The method of claim 1, wherein the plot includes data corresponding to at least one of an early-time region, a middle-time region, or a late-time region.

8. The method of claim 1, wherein the trend indicates damage to the well.

9. The method of claim 8, wherein the damage corresponds to high skin damage or low skin damage.

10. The method of claim 1, wherein the well drawdown strategy is applied to the well or to a future well.

11. A system for optimizing production of a reservoir, the system comprising:
a production optimization platform receiving well data corresponding to a well, determining at least one rate and time dependent property using the well data, generating a plot of the at least one rate and time dependent property relative to a pressure of the well, analyzing the plot to determine a trend, and generating a well drawdown strategy based on the trend.

12. The system of claim 11, wherein the well data comprises build-up data, production rate data, pressure data, flowback data, or combinations thereof.

13. The system of claim 11, wherein the production optimization platform repeats the receiving, determining, generating, analyzing, and generating for a plurality of wells.

14. The system of claim 13, wherein the production optimization platform categorizes each well of the plurality of wells as one of a low drawdown well, a medium drawdown well, or a high drawdown well.

15. The system of claim 13, wherein the production optimization platform overlays a plurality of plots corresponding to the plurality of wells onto a composite plot.

16. One or more non-transitory computer-readable media storing instructions that, when executed by one or more processors of a computing system, cause the computing system to perform operations comprising:
receiving well data corresponding to a well;
determining at least one rate and time dependent property using the well data;
generating a plot of the at least one rate and time dependent property relative to a pressure of the well;
analyzing the plot to determine a trend; and
generating a well drawdown strategy based on the trend.

17. The one or more non-transitory computer-readable media of claim 16, wherein the well data comprises high frequency dynamic data collected at sampling intervals of seconds, minutes, or hours.

18. The one or more non-transitory computer-readable media of claim 16, wherein the at least one rate and time dependent property comprises a flow capacity or a skin effect.

19. The one or more non-transitory computer-readable media of claim 16, wherein the trend comprises an interference response between the well and another well.

20. The one or more non-transitory computer-readable media of claim 16, wherein the well drawdown strategy comprises a lower drawdown condition, a higher drawdown condition, or a modified flowback strategy.
